(19) United States
(12) Patent Application Publication
(10) Pub. No.: US 2008/0116794 A1
(43) Pub. Date: May 22, 2008

(54) ELECTRON EMISSION DEVICE AND LIGHT EMISSION DEVICE HAVING THE ELECTRON EMISSION DEVICE

(76) Inventors: Jin-Hui Cho, Yongin-si (KR); Sang-Jo Lee, Yongin-si (KR); Sam-Il Han, Yongin-si (KR); Jin-Ho Bin, Yongin-si (KR); Sang-Ho Jeon, Yongin-si (KR); Su-Bong Hong, Yongin-si (KR)

Correspondence Address: CHRISTIE, PARKER & HALE, LLP, PO BOX 7068, PASADENA, CA, 91109-7068, US

(21) Appl. No.: 11/866,972

(22) Filed: Oct. 3, 2007

(30) Foreign Application Priority Data
Nov. 17, 2006 (KR) 10-2006-0113992

(51) Int. Cl. H01J 1/62

(52) U.S. Cl. 313/509

(57) ABSTRACT

An electron emission device includes a substrate, a cathode electrode located on the substrate and having a first opening, the cathode electrode including a material that substantially blocks ultraviolet rays, an electron emission region that is located in the first opening and adapted to emit electrons, a gate electrode that is electrically insulated from the cathode electrode, the gate electrode including a material that substantially blocks ultraviolet rays, and a plurality of insulation layers located between the cathode and gate electrodes. The plurality of insulation layers includes first and second insulation layers adjacent to each other. The first insulation layer has a first etching rate that is different from a second etching rate of the second insulation layer.

### CROSSED-REFERENCE TO RELATED APPLICATION

This application claims priority to and the benefit of Korean Patent Application No. 10-2006-0113992 filed on Nov. 17, 2006 in the Korean Intellectual Property Office, the entire content of which is incorporated herein by reference.

### BACKGROUND OF THE INVENTION

1. Field of the Invention

The present invention relates to a light emission device, and a display having the light emission device.

2. Description of Related Art

In a field emitter array (FEA) type electron emission device, an FEA element includes an electron emission region, and cathode and gate electrodes functioning as driving electrodes for controlling the electron emission of the electron emission region. The electron emission region is formed of a material having a relatively low work function or a relatively large aspect ratio, e.g., a carbon-based material such as carbon nanotubes, graphite, and diamond-like carbon, so as to effectively emit electrons when an electric field is formed around the electron emission regions under a vacuum atmosphere. The electron emission elements are arrayed on a first substrate to constitute an electron emission device. The electron emission device is combined with a second substrate, on which a light emission unit having phosphor layers and an anode electrode is formed, to constitute a light emission device.

### SUMMARY OF THE INVENTION

In exemplary embodiments according to the present invention, an electron emission device having openings that are uniformly and finely formed, is provided. Electron emission regions are located in these openings. In other exemplary embodiments, a method of manufacturing the electron emission device is provided. In other exemplary embodiments, a light emission device having an electron emission device is provided.

In an exemplary embodiment of the present invention, an electron emission device is provided. The electron emission device includes: a substrate; a cathode electrode on the substrate and having a first opening, the cathode electrode comprising a material that substantially blocks ultraviolet rays; an electron emission region in the first opening, the electron emission region being adapted to emit electrons; a gate electrode electrically insulated from the cathode electrode, the gate electrode comprising a material that substantially blocks ultraviolet rays; and a plurality of insulation layers between the cathode electrode and the gate electrode. The plurality of insulation layers includes first and second insulation layers adjacent each other, the first insulation layer having a first etching rate different from a second etching rate of the second insulation layer.

The first insulation layer may be an etching control layer, and the first etching rate may be less than the second etching rate. The second etching rate may be 2-3 times the first etching rate. The second insulation layer may be closer to the substrate than the first insulation layer.

The second insulation layer may have an opening formed through an etching process, where a radius of the opening gradually increases toward the substrate. A thickness of the second insulation layer may be equal to or less than the radius of the opening. A thickness of the second insulation layer may be equal to or less than 90% of the radius of the opening.

The etching control layer may include at least one of silicon oxide or silicon nitride. When the etching control layer is formed of the silicon oxide and the second insulation layer is formed of another silicon oxide, then a ratio of oxygen to silicon in the etching control layer may be greater than a ratio of oxygen to silicon in the second insulation layer. Thus, the ratio of oxygen to silicon in the first type of silicon oxide may be greater than the ratio of oxygen to silicon in the second type of silicon oxide. When the etching control layer is formed of silicon oxide, the silicon oxide may have a chemical formula of SiₓO_{y} and satisfy the following condition: 2x≧y. A thickness of the etching control layer may be 5-10% of that of the thickness of the second insulation layer.

The electron emission device may further include a third insulation layer located on the gate electrode, and a focusing electrode that is formed on the third insulation layer and includes material that substantially blocks the ultraviolet rays.

In another exemplary embodiment of the present invention, a light emission device is provided. The light emission device includes: first and second substrates opposing each other; a cathode electrode on the first substrate and having a first opening, the cathode electrode comprising a material that substantially blocks ultraviolet rays; an electron emission region in the first opening, the electron emission region being adapted to emit electrons; a gate electrode electrically insulated from the cathode electrode, the gate electrode comprising a material that substantially blocks ultraviolet rays; a plurality of insulation layers between the cathode electrode and the gate electrode; a phosphor layer on the second substrate; and an anode electrode adjacent the phosphor layer on the second substrate. The plurality of insulation layers includes a first insulation layer and a second insulation layer, the first insulation layer having a first etching rate different from a second etching rate of the second insulation layer.

The first insulation layer may be an etching control layer, and the first etching rate may be less than the second etching rate. The second insulation layer may have an opening formed through an etching process, and a radius of the opening gradually increases toward the substrate.

The etching control layer may include at least one of silicon oxide or silicon nitride. When the etching control layer is formed of the silicon oxide and the second insulation layer is formed of another silicon oxide, a ratio of oxygen to silicon in the etching control layer may be greater than a ratio of oxygen to silicon in the second insulation layer.

### BRIEF DESCRIPTION OF THE DRAWINGS

FIG. 1 is a schematic exploded perspective view of a light emission device having an electron emission device according to a first exemplary embodiment of the present invention.

FIG. 2 is a sectional view of the light emission device of FIG. 1.

FIGS. 3A, 3B, 3C, 3D, 3E, 3F, 3G, 3H, 31, 3J, 3K and 3L are views illustrating sequential processes for manufacturing the electron emission device of FIG. 1.

FIG. 4 is a schematic sectional view of a light emission device having an electron emission device according to a second exemplary embodiment of the present invention.

FIGS. 5A, 5B, 5C, 5D, 5E, 5F, 5G, 5H, 51, 5J and 5K are views illustrating sequential processes for manufacturing the electron emission device of FIG. 4.

### DETAILED DESCRIPTION OF THE EMBODIMENTS

Exemplary embodiments of the present invention will now be described more fully with reference to the accompanying drawings. Those skilled in the art will be able to implement the embodiments using the disclosure herein. Those skilled in the art would realize that the described embodiments may be modified in various different ways, all without departing from the spirit or scope of the present invention. Wherever possible, the same reference numbers will be used throughout the drawings to refer to the same or like parts.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. The terms “comprises” and/or “comprising,” or “includes” and/or “including,” “forms” and/or “formed,” when used, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” “over,” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, “below” can encompass both an orientation of above and below. The device may be otherwise oriented (rotated 90 degrees or at other orientations) and the spatially relative descriptors used herein are interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to perspective views that are schematic illustrations of idealized embodiments of the present invention. As such, variations from the shapes of the illustrations as a result of, for example, manufacturing techniques and/or tolerances, are to be expected. Thus, embodiments should not be construed as limited to the particular shapes of regions illustrated herein but are to include deviations in shapes that result, for example, from manufacturing. As an example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

In exemplary embodiments of the present invention, all devices that emit light to an external side are regarded as light emission devices. Therefore, all displays that transmit information by displaying symbols, letters, numbers, or images can be regarded as light emission devices. The light emission device is used as a light source by itself or may use an external light source. Therefore, a device that reflects external light can be regarded as a light emission device.

Reference will now be made in detail to exemplary embodiments of the present invention. The invention should not be construed as being limited to the exemplary embodiments set forth herein; rather, the exemplary embodiments are provided so that this disclosure will be thorough and complete, and will fully convey the concept of the invention to those skilled in the art.

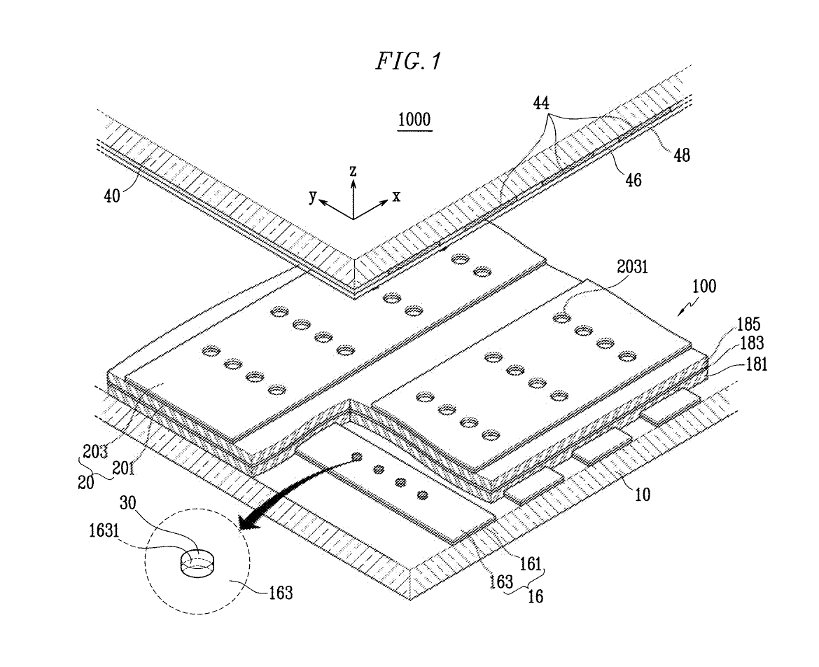

FIG. 1 shows an exploded perspective view of a light emission device having an electron emission device according to an exemplary embodiment of the present invention. An enlarged electron emission region is shown in the enlarged circle of FIG. 1.

An electron emission device 100 having a plurality of electron emission elements arrayed on a first substrate 10 is combined with a second substrate 40 on which an anode electrode 48 and phosphor layers 44 are formed, thereby constituting a light emission device 1000. Light is emitted through an outer surface of the second substrate 40.

As shown in FIG. 1, the electron emission device 100 includes, in addition to the first substrate 10, cathode electrodes 16, electron emission regions 30, insulation layers 181, 183, and 185, and gate electrodes 20. In other embodiments, the electron emission device 100 may further include other elements as needed.

The cathode electrodes 16 are spaced apart from each other, and are extending along a y-axis. Each of the cathode electrodes 16 includes a first conductive layer 161 and a second conductive layer 163. The first conductive layers 161 are formed of a transparent conductive material such as indium tin oxide (ITO) to facilitate a backside exposure process. Therefore, the electron emission device 100 can be manufactured by irradiating ultraviolet rays into the device through a backside of the first substrate 10.

The second conductive layer 163 is electrically connected to the first conductive layer 161. Since the first conductive layer 161 is formed of ITO, or the like, its resistivity is high. Therefore, the electrons are not uniformly emitted from the electron emission regions 30 due to the voltage-drop of the cathode electrodes 16. As a result, the second conductive layers 163 are provided to reduce or prevent the voltage-drop of the cathode electrodes 16. Therefore, the second conductive layers 163 are formed of metal such as aluminum. The second conductive layers 163 are provided with openings 1631. Since ultraviolet rays cannot be transmitted through the second conductive layer 163, the openings 1631 can be formed through a backside exposure process.

As shown in the enlarged circle of FIG. 1, the electron emission regions 30 are provided in the openings 1631. The electron emission regions 30 are formed of a material for emitting electrons when an electric field is applied thereto under a vacuum atmosphere, such as a carbon-based material or a nanometer-sized material. For example, the electron emission regions 30 can be formed of carbon nanotubes, graphite, graphite nanofibers, diamonds, diamond-like carbon, fullerene C₆₀, silicon nanowires or a combination thereof. The electron emission regions 30 may be formed through a screen-printing process, a direct growth process, chemical deposition process, or a sputtering process. Alternatively, the electron emission regions 30 may be formed in a tip structure formed of a Mo-based or Si-based material.

The insulation layers 181, 183, and 185 are located above the cathode electrodes 16 to insulate the cathode electrodes 16 from the gate electrodes 20. The insulation layers 181, 183, and 185 are located on an entire surface of the first substrate 10, and cover the cathode electrodes 16. The gate electrodes 20 are formed in a striped pattern extending in an x-axis. Each of the gate electrodes 20 includes a third conductive layer 201 and a fourth conductive layer 203. The third conductive layers 201 are formed of a transparent material such as the ITO to facilitate a backside exposure process. Therefore, since the third conductive layer 201 has a high resistivity, the fourth conductive layer 203 is located on the third conductive layer 201 in order to reduce or prevent a driving voltage-drop of the gate electrode 20. The fourth conductive layer 203 is formed of a nontransparent material such as aluminum.

The fourth conductive layers 203 have openings 2031 at each region where the gate and cathode electrodes 20 and 16 cross each other. The electrons emitted from the electron emission regions 30 pass through the openings 2031. In one embodiment, the crossing regions of the cathode and gate electrodes 16 and 20 define pixel regions. Therefore, a plurality of the electrons are emitted from the electron emission regions 30 of each pixel region.

The second substrate 40 is oriented so that it faces the first substrate 10. The phosphor layers 44 and the anode electrode 48 are located on the second substrate 40. In the embodiment of FIG. 1, a black layer 46 is located between the phosphor layers 44 to absorb external light, thereby enhancing contrast. In other embodiments, a black layer may not be used. The electrons collide with the phosphor layers 44 to emit visible light from the phosphor layers 44. The phosphor layers 44 may be a white phosphor layer or may have red, green and blue phosphor layers.

The anode electrode 48 is located on the phosphor and black layers 44 and 46. The anode electrode 48 may be formed of metal such as aluminum. In other embodiments, the phosphor and black layers 44 and 46 may be formed on the anode electrode 48. Since the anode electrode 48 is applied with a high voltage of about 10-20 kV, the electrons emitted from the electron emission regions 30 collide with the phosphor layers 44 by being accelerated by the high voltage applied to the anode electrode 48.

FIG. 2 shows a cross-section of the light emission device 1000 illustrated in FIG. 1. In the enlarged circle of FIG. 2, a portion of the light emission device where the electron emission region 30 is located, is illustrated.

A sealing member (not shown) is used at the peripheries of the first and second substrates 10 and 40 to seal them together, and thereby creating a vessel. The interior of the vessel is exhausted to a vacuum state of about 10⁻⁶ To rr.

As shown in FIG. 2, spacers 50 are located between the first and second substrates 10 and 40 to uniformly maintain a gap between the first and second substrates 10 and 40, even when an external force is applied to the vacuum vessel. The spacers 50 are located at locations corresponding to the black layer 46 such that they do not interfere with the light emission of the phosphor layers 44.

The operating procedure of the light emission device 100 is explained as follows. First, suitable voltages (e.g., predetermined voltages) are applied to the cathode, gate, and anode electrodes 16, 20, and 48 from outside sources. For example, one of the cathode and gate electrodes 16 and 20 functions as a scan electrode that receives a scan driving voltage while the other functions as a data electrode that receives a data driving voltage. The anode electrode 48 receives a direct current (DC) voltage of, for example, hundreds to thousands of volts that can accelerate the electron beams.

Electric fields are formed around the electron emission regions 30 at the unit pixels where a voltage difference between the cathode and gate electrodes 16 and 20 is equal to or higher than a threshold value and thus the electrons are emitted from the electron emission regions 30. The emitted electrons collide with the phosphor layers 44 of the corresponding pixels by the high voltage applied to the anode electrode 48, thereby exciting the phosphor layers 44 to realize an image.

As shown in the enlarged circle of FIG. 2, an opening (or opening area) 187 is formed on each electron emission region 30. In this first exemplary embodiment, by successively etching the insulation layers 181, 183, and 185, the size of the opening 187 can be reduced or minimized. Therefore, the density of the openings (i.e., number of openings per unit area) 187 increases and thus an increased number of electron emission regions 30 can be formed. Hence, the amount of electrons emitted from the electron emission regions 30 increases.

In a typical wet-etching process, the insulation layer is etched by injecting an etching solution through openings formed in the photoresist. In this case, the etching rate in a horizontal direction is substantially identical to the etching rate in the vertical direction. Therefore, the radius of the hole formed through etching is substantially the same as the thickness of the insulation layer. As a result, the greater the thickness of the insulation layer, the greater the radius of the hole. Therefore, it is difficult to increase the density (i.e., a number per unit area) of the electron emission regions.

In the first exemplary embodiment of the present invention, the density (i.e., a number per unit area) of the electron emission regions 30 can be increased by individually and sequentially etching the insulation layers 181, 183, and 185. That is, by etching the insulation layers 181, 183, and 185 one after another, the size of the opening 187 can be reduced or minimized. Therefore, during the etching process, the radius of the opening 187 is determined by the thickness of each one of the insulation layers 181, 183, and 185. Since the etching of the insulation layers 181, 183, and 185 is performed in multiple steps, the radius of the openings does not continually increase while etching through the total thickness of the insulation layers 181, 183, and 185. That is, after one of the insulation layers 181, 183, or 185 is etched, the subsequent etching of another one of the insulation layers 181, 183, or 185 substantially does not increase the radius of the opening 187.

In the first exemplary embodiment, the etching rates of the insulation layers 181, 183, and 185 vary. In other words, the insulation layers 181, 183, and 185 have different etching rates. By adjusting the etching rates, the sizes of the opening 187 in different insulation layers can be maintained to be substantially the same.

For convenience, the insulation layers 181, 183, and 185 will be referred to as “first insulation layer” 181, “etching control layer” 183, and “second insulation layer” 185. The etching rate of the etching control layer 183 is different from those of the first and second insulation layers 181 and 185. By varying the etching rates of the insulation layers 181, 183, and 185, the size increase of the opening 187 can be reduced or minimized.

For example, because of the etching control layer 183, only the second insulation layer 185 is etched and no more etching occurs. After the second insulation layer 185 is etched, the etching control layer 183 and the first insulation layer 181 can be concurrently etched. Therefore, by adjusting the location of the etching control layer 183, the etching depth can be controlled during the multi-step etching process.

The etching rate of the etching control layer 183 is less than that of the first insulation layer 181. In one embodiment, the etching rate of the first insulation layer 181 is two to three times that of the etching control layer 183. Accordingly, in the wet-etching process, the first insulation layer 181, which is close to the first substrate 10, is etched more than the etching control layer 183. As shown in the enlarged circle, the radius (r) of the opening 187 increases as it approaches the first substrate 10. However, the radius (r) of the opening 187 in different insulation layers can be maintained substantially uniformly using the multi-step etching process. Therefore, the openings 187 having substantially uniform radius through the insulation layers 181, 183, and 185 can be realized. The radius (r) of each of the openings 187 refers to the measurement taken in a direction parallel to the first substrate 10. Therefore, the radius (r) of the opening 187 may be varied.

The thickness (t1) of the first insulation layer 181 may be equal to or less than the radius (r) of the opening 187. The thickness (t3) of the second insulation layer 185 may also be equal to or less than the radius (r) of the opening 187. By making each of the thicknesses (t1, t3) of the first and second insulation layers 181 and 185 equal to or less than the radius (r) of the opening 187, the size of the opening 187 can be reduced by a maximum amount. By controlling the etching rate using the etching control layer 183, the thickness (t1) of the first insulation layer 181 does not exceed the radius (r) of the opening 187. In more detail, the thickness (t1) of the first insulation layer 181 may be equal to or less than 90% of the radius (r) of the opening 187. When the thickness (t1) of the first insulation layer 181 is greater than 90% of the radius (r) of the opening 187, the size of the opening 187 increases thereby deteriorating the density (i.e., a number per unit area) of the electron emission regions 30.

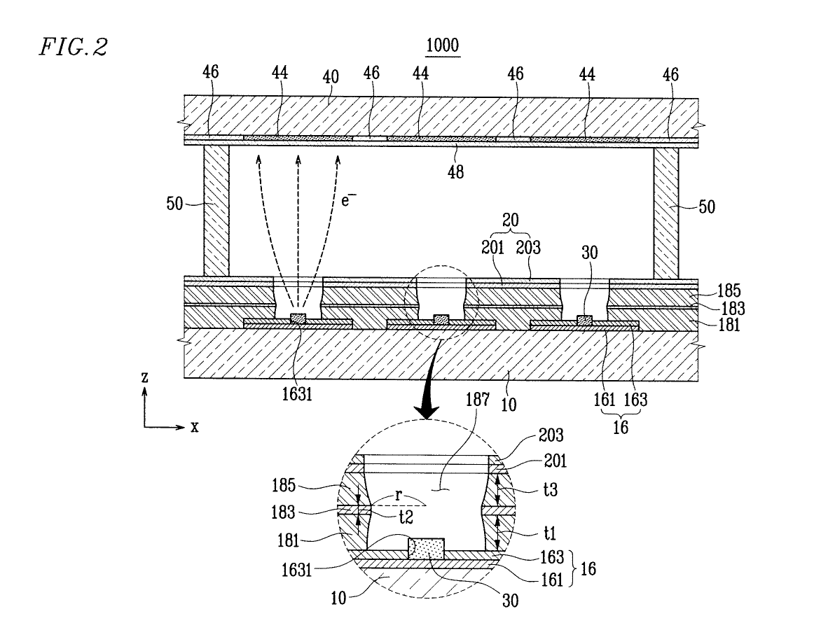

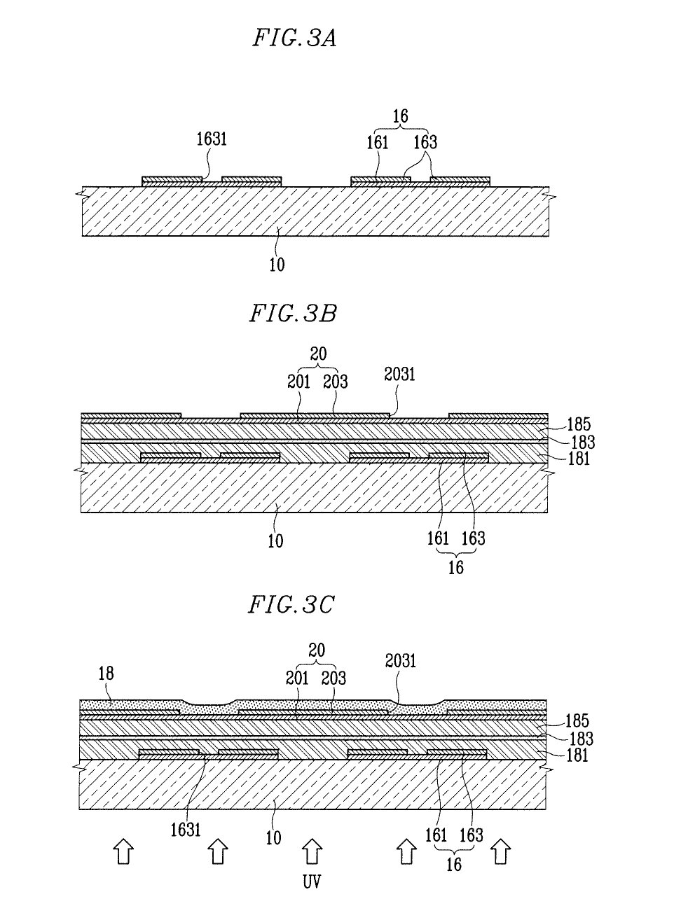

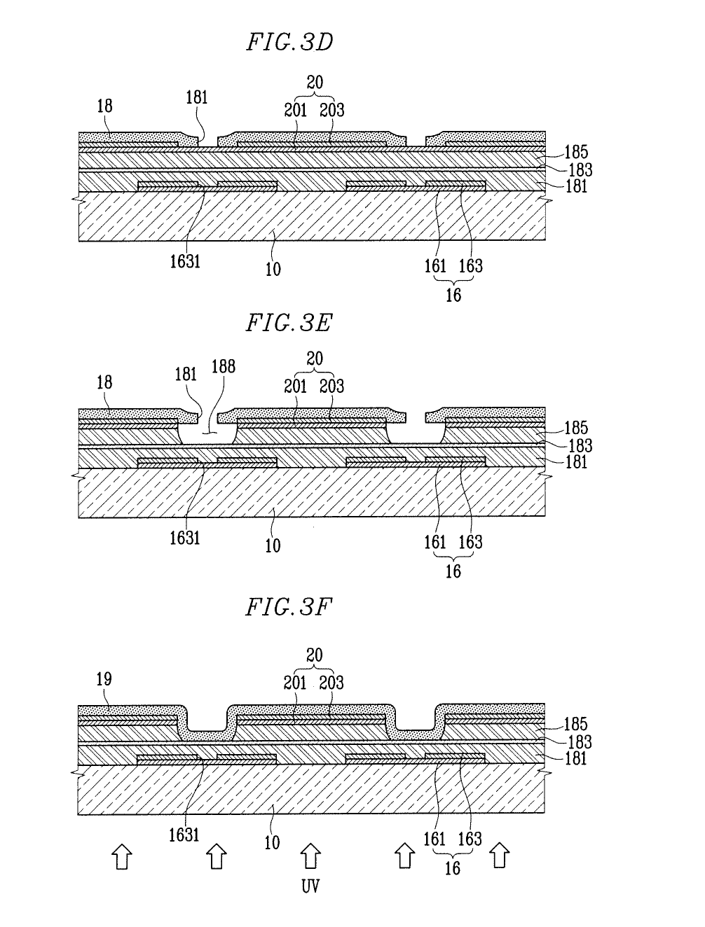

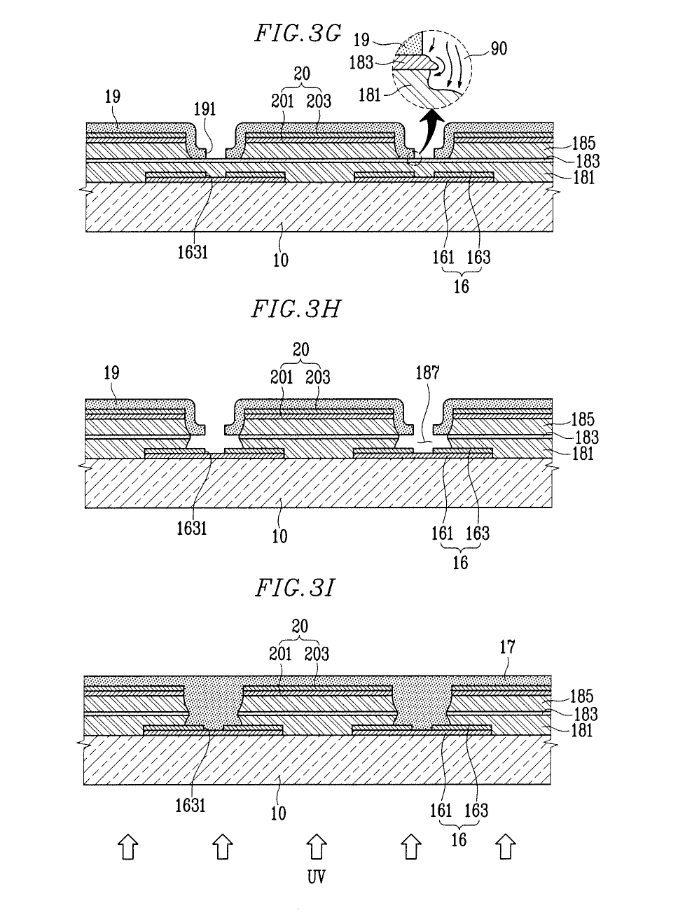

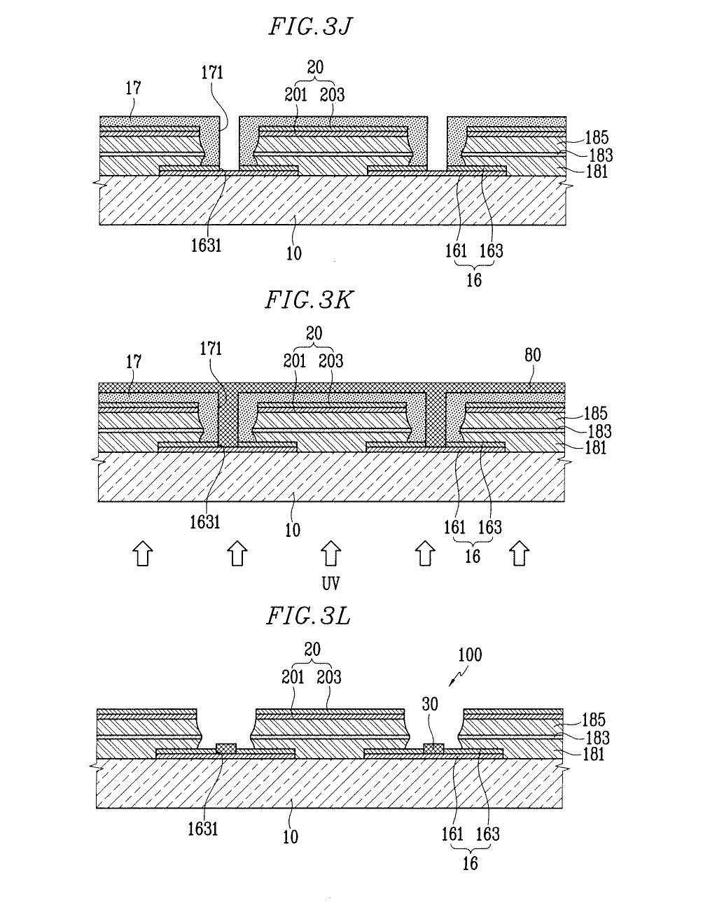

The thickness (t2) of the etching control layer 183 may range from 5% to 10% of the thickness (t1) of the first insulation layer 181. If the thickness (t2) of the etching control layer 183 is less than 5% of the thickness (t1) of the first insulation layer 181, the etching retardation effect of the etching control layer 183 cannot be sufficiently obtained. If the thickness (t2) of the etching control layer 183 is greater than 10% of the thickness (t1) of the first insulation layer 181, etching is excessively retarded. The etching relationship between the etching control layer 183 and the first insulation layer 181 will be described in more detail later with reference to FIG. 3G.

The following will describe a method of manufacturing the electron emission device 100 according to a first exemplary embodiment of the present invention with reference to FIGS. 3A, 3B, 3C, 3D, 3E, 3F, 3G, 3H, 31, 3J, 3K and 3L.

As shown in FIG. 3A, a conductive layer is coated on the first substrate 10 and processed in a striped pattern to form the first and second conductive layers 161 and 163. The openings 1631 are formed in the second conductive layer 163. The openings 1631 are formed in, for example, a circular shape at portions where the electron emission regions will be formed. This way, the cathode electrodes 16 are formed.

As shown in FIG. 3B, insulation materials are deposited on the first substrate 10, and cover the cathode electrodes 16, thereby forming the insulation layers 181, 183, and 185 each having a suitable thickness (e.g., a predetermined thickness). The insulation layers 181, 183, and 185 may be formed through a chemical vapor deposition process or a screen-printing process. The insulation material for the insulation layers 181, 183, and 185 may be a transparent material that allows ultraviolet rays to pass through. In other words, the insulation material transmits ultraviolet rays.

The etching control layer 183 may be formed of silicon oxide and/or silicon nitride. The first and second insulation layers 181 and 185 may be formed of silicon oxide. By controlling the ratio of oxygen to silicon, the etching rate of the etching control layer 183 can be controlled to be less than that of the first insulation layer 181. Therefore, the etching rate of the first insulation layer 181 can be retarded by the etching control layer 183. This happens when both the etching control layer 183 and the first insulation layer 181 are formed of silicon oxide and the ratio of oxygen to silicon in the silicon oxide of the etching control layer 183 is greater than the ratio of oxygen to silicon in the silicon oxide of the first insulation layer 181. In more detail, the silicon oxide (SiₓO_{y}) contained in the etching control layer 183 may satisfy Equation 1.

2x≧y Equation 1

Twice the mole number of the silicon in the silicon oxide may be equal to or greater than the mole number of the oxygen in the silicon oxide. In one embodiment, if twice the mole number of the silicon in the silicon oxide is less than the mole number of the oxygen, the etching control layer 183 cannot effectively retard the etching of the first insulation layer 181.

As shown in FIG. 3B, the gate electrodes 20 are formed on the second insulation layer 185 in a striped pattern extending in a direction crossing the cathode electrodes 16. After forming the third conductive layer 201 on the second insulation layer 185, the fourth conductive layer 203 is formed on the third conductive layer 201. The openings 2031 are formed in the fourth conductive layer 203.

As shown in FIG. 3C, a first photoresist 18 is deposited and covers the gate electrodes 20. The first photoresist 18 is a positive type where an exposed portion is dissolved. Subsequently, ultraviolet rays are irradiated on the first photoresist 18 through the backside of the first substrate 10. Since the second and fourth conductive layers 163 and 203 are formed of nontransparent material that does not transmit (i.e., blocks or substantially blocks) ultraviolet rays, the ultraviolet rays pass only through the openings 1631. As a result, portions of the first photoresist 18 corresponding to the openings 1631 absorb the ultraviolet rays.

Next, as shown in FIG. 3D, the ultraviolet ray absorbing portions of the photoresist 18 are developed and removed to form the openings 181 therein. Therefore, the wet-etching process can be performed through the openings 181 of the photoresist 18.

As shown in FIG. 3E, the third conductive layer 201 and the second insulation layer 185 are etched through the openings 181. Since the etching rate of the etching control layer 183 is less than that of the second insulation layer 185, the etching control layer 183 is not etched. Since the second insulation layer 185 is relatively thin, the diameter of an opening 188 is therefore small.

Referring to FIG. 3F, a second photoresist 19 is deposited on the second insulation layer 185 and covers the gate electrodes 20. Subsequently ultraviolet rays are irradiated on the second photoresist 19 through the backside of the first substrate 10. The second photoresist 19 is a positive type where an exposed portion is dissolved. Since the second and fourth conductive layers 163 and 203 are formed of nontransparent material that does not transmit ultraviolet rays, the ultraviolet rays pass only through the openings 1631. As a result, portions of the second photoresist 19 corresponding to the openings 1631 absorb the ultraviolet rays.

Next, as shown in FIG. 3G, the ultraviolet ray absorbing portions of the photoresist 19 are developed and removed to form the openings 191 therein. In the enlarged circle of FIG. 3G, a wet-etching process using an etching solution 90 is shown.

As shown in the enlarged circle of FIG. 3G, the etching control layer 183 and the first insulation layer 181 are etched through the wet-etching process. That is, the etching solution etches the etching control layer 183 and the first insulation layer 181 while flowing in the direction of the arrow. As previously described, since the etching rate of the etching control layer 183 is less than that of the first insulation layer 181, the etching control layer 183 is not etched. Also, since the second insulation layer 185 is relatively thin, the diameter of the openings 188 is small.

For example, the etching rate of the first insulation layer 181 may be two or three times that of the etching control layer 183. If the etching rate of the first insulation layer 181 is less than two times the etching control layer 183, the etching of the first insulation layer 181 may be excessively retarded. If the etching rate of the first insulation layer 181 is greater than three times the etching control layer 183, the etching of the first insulation layer 181 proceeds too quickly. Therefore, the etching solution 90 may be diffused horizontally while flowing downward.

Referring to FIG. 3H, the etching amount of the first insulation layer 181 increases as it approaches the first substrate 10. Accordingly, the opening 187 can be formed with a relatively uniform diameter. In addition, the size of the opening 187 is reduced through the multi-step etching process. Since the amount of the etching solution used at each time is small, corrosion of the first substrate 10 and the first conductive layer 161 by the etching solution can be reduced or prevented.

Next, as shown in FIG. 3I, a third photoresist 17 is deposited above the gate and cathode electrodes 20 and 16. Subsequently, ultraviolet rays are irradiated on the third photoresist 17 through the backside of the first substrate 10. The third photoresist 17 is a positive type where an exposed portion is dissolved. Since the second and fourth conductive layers 163 and 203 are formed of nontransparent material that does not transmit ultraviolet rays, the ultraviolet rays pass only through the openings 1631. As a result, portions of the third photoresist 17 corresponding to the openings 1631 absorb the ultraviolet rays.

Referring to FIG. 3J, the ultraviolet ray absorbing portions of the photoresist 17 are developed and removed to form the openings 171 therein (see FIG. 1).

Next, as shown in FIG. 3K, a paste-phase mixture 80, including an electron emission material and a photosensitive material, is deposited on the third photoresist through a screen-printing process. Subsequently, ultraviolet rays are emitted toward the resultant layer 80 through the backside of the first substrate 10. Since the second and fourth conductive layers 163 and 203 are formed of nontransparent material that does not transmit ultraviolet rays, the ultraviolet rays pass only through the openings 1631. As a result, portions of the resultant layer 80 corresponding to the openings 1631 are hardened. The portions that are not hardened are removed through the developing process and the third photoresist 17 is removed. Next, the hardened portions are dried and baked.

Accordingly, as shown in FIG. 3L, the electron emission device 100 can be manufactured in such a manner that the electron emission regions 30 are formed in the openings 1631. Since the electron emission regions 30 are hardened through backside exposure, the adhesive force of the first substrate 10 can be improved. If required, an activation process for exposing the electron emission material to surfaces of the electron emission regions 30 by attaching and detaching a pressure-sensitive tape on and from the first substrate 10 can be further preformed to improve the electron emission efficiency of the electron emission regions 30.

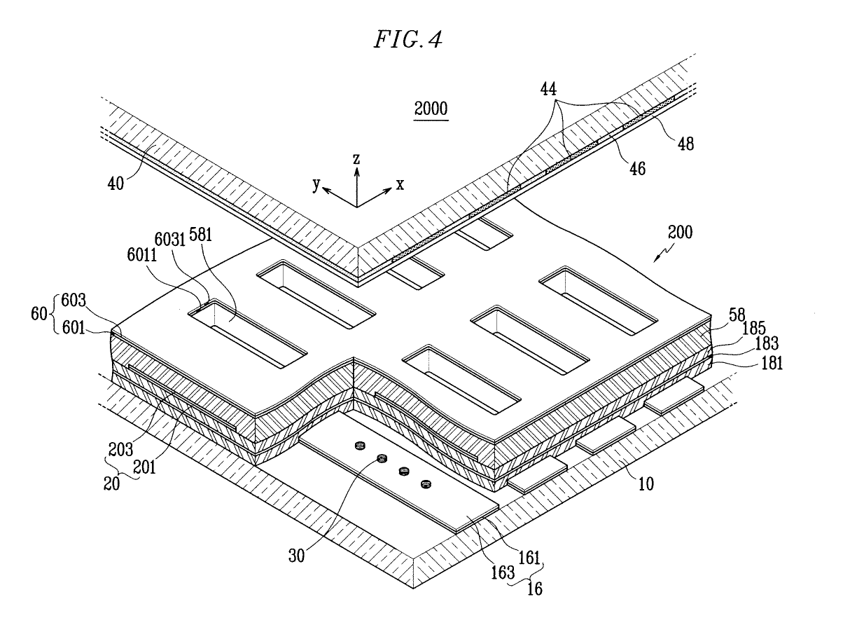

FIG. 4 is a light emission device having an electron emission device according to a second exemplary embodiment of the present invention. Since the structure of a light emission device 2000 illustrated in FIG. 4 is identical to that of the light emission device illustrated in FIG. 1, except for a focusing electrode 60 and a third insulation layer 38, the same reference numbers will be used to refer to the same or like parts and a detailed description of the same or like parts will be omitted herein.

As shown in FIG. 4, the third insulation layer 58 covers the gate electrodes 20, thereby insulating the gate electrodes 20 from the focusing electrode 60. The focusing electrode 60 includes a fifth conductive layer 601 and a sixth conductive layer 603. The sixth conductive layer 603 is formed on the fifth conductive layer 601. The fifth conductive layer may be formed of ITO or the like. The sixth conductive layer 603 may be formed of a nontransparent material that does not transmit ultraviolet rays. For example, the sixth conductive layer 603 may be formed of aluminum.

Openings 6011 and openings 6031 are respectively formed in the first and sixth conductive layers 601 and 603. Openings 581 are formed in the third insulation layer 58 to allow the electrons emitted from the electron emission regions 30 to pass therethrough. When a driving voltage is applied to the focusing electrode 60, the electrons are converged while passing through the focusing electrode 60, thereby improving the display quality of the light emission device 2000.

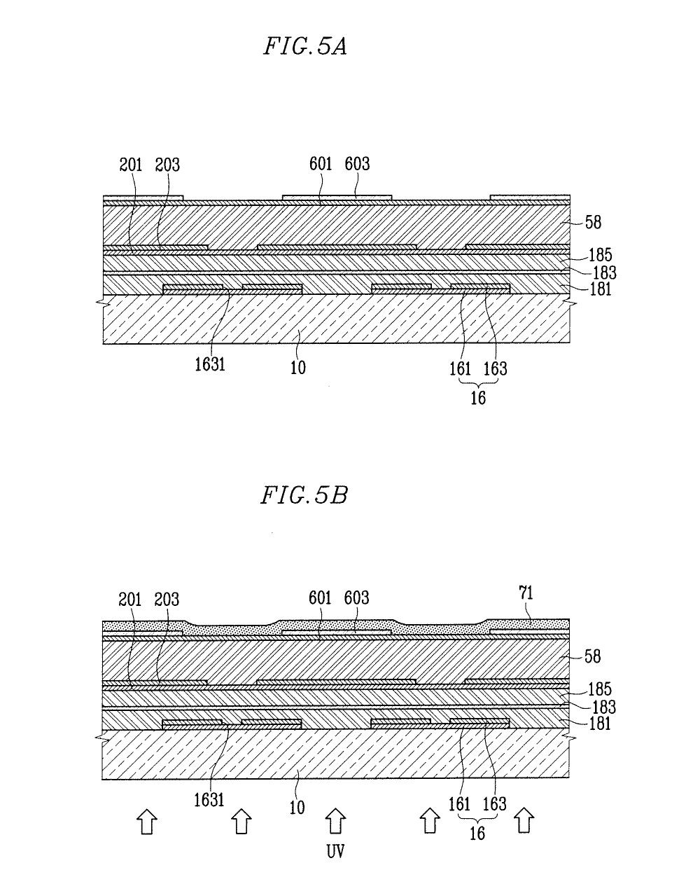

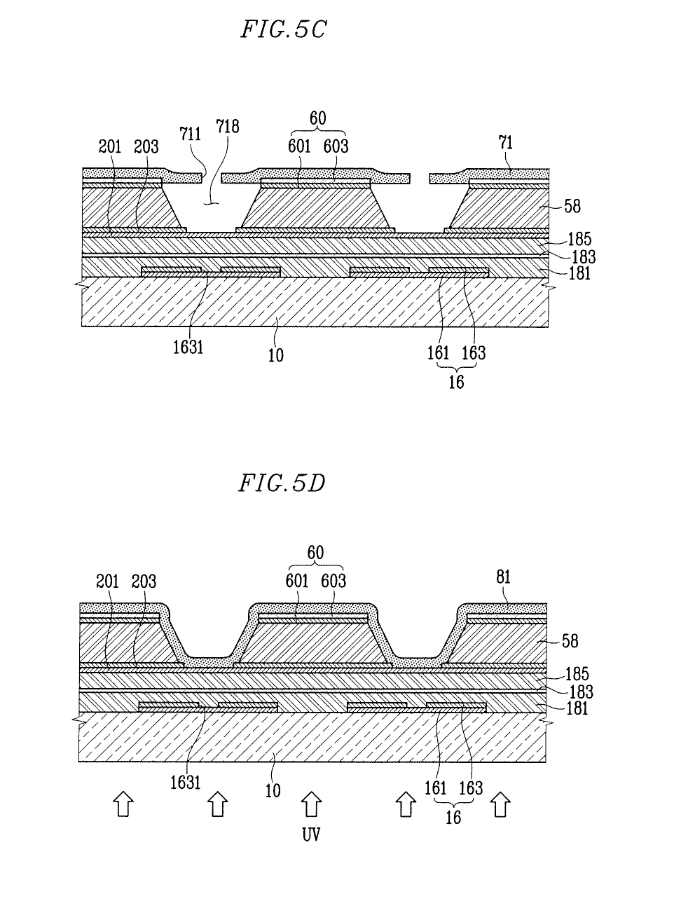

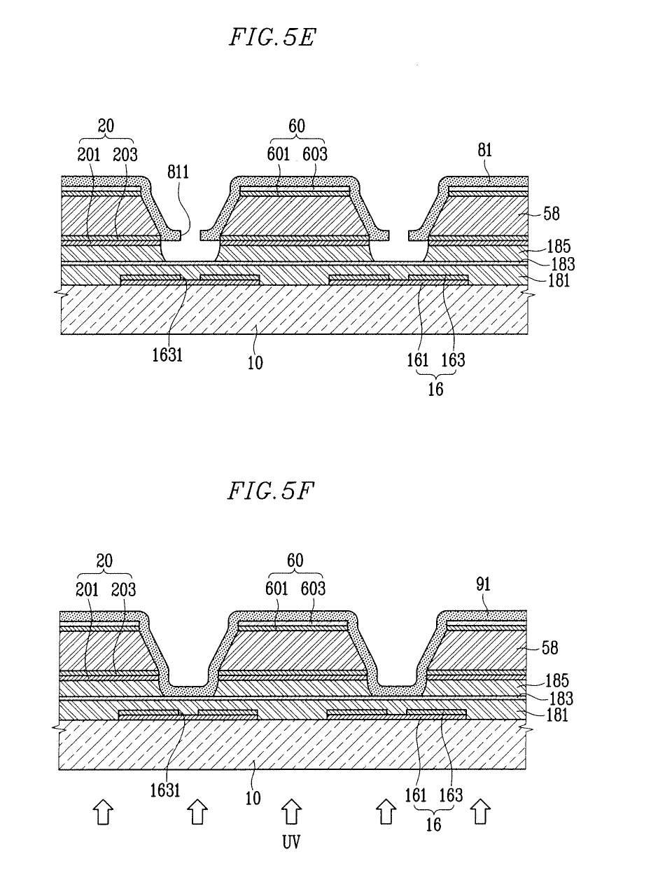

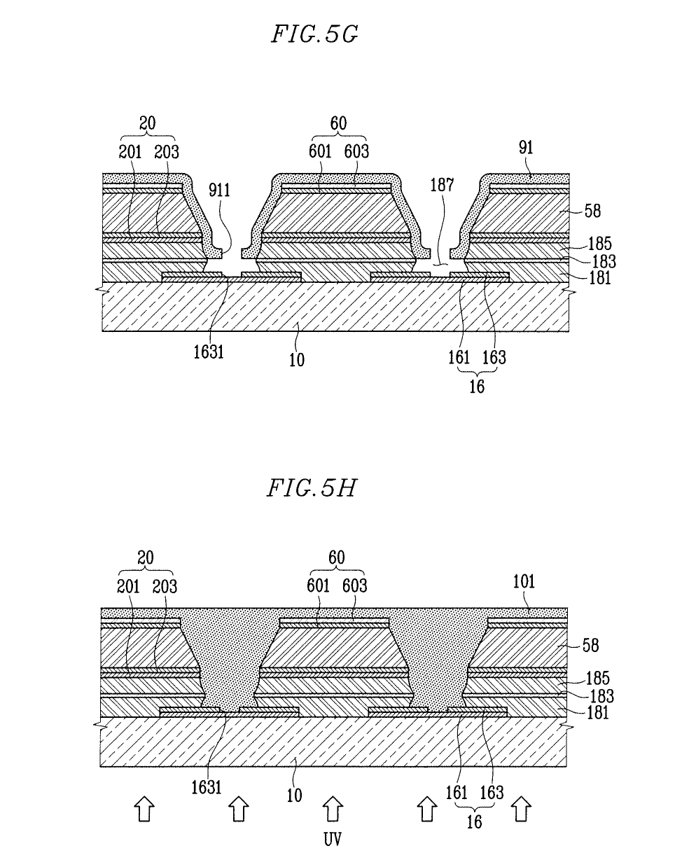

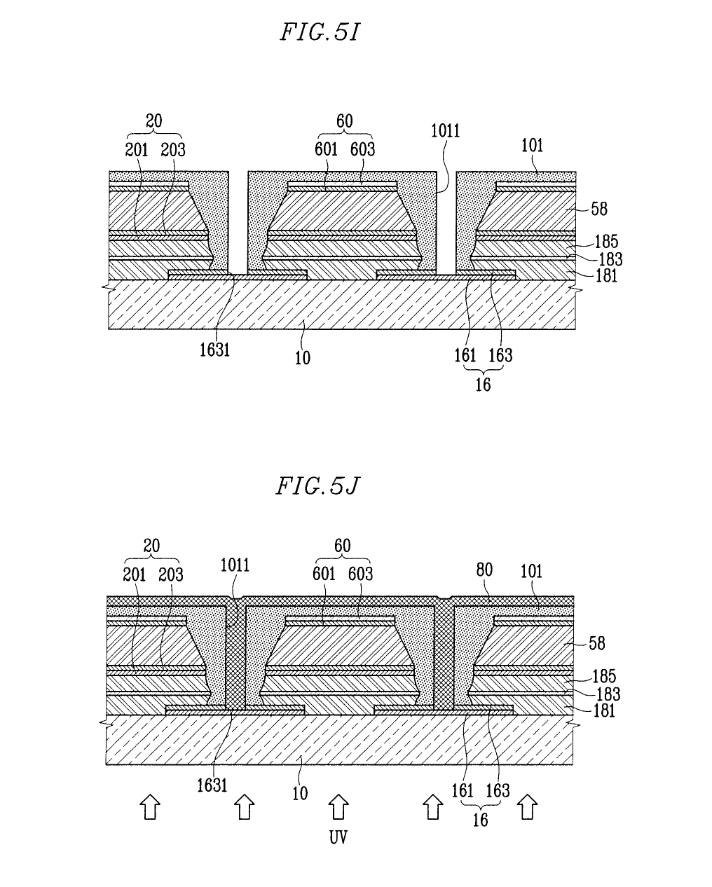

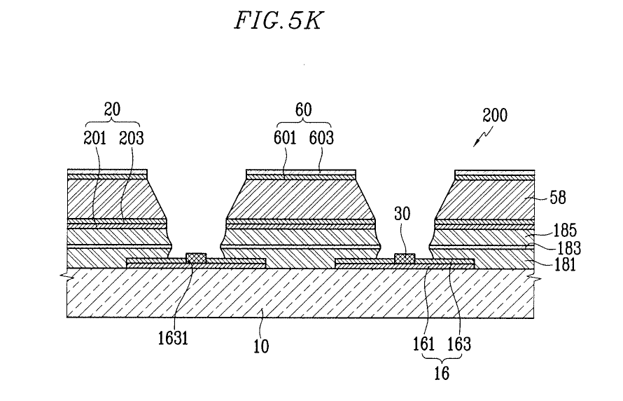

FIGS. 5A, 5B, 5C, 5D, 5E, 5F, 5G, 5H, 51, 5J and 5K illustrate a method of manufacturing the electron emission device of FIG. 4. Since a method illustrated in FIGS. 5A to 5K is similar to that illustrated in FIGS. 3A to 3L, the like processes will not be illustrated for convenience.

The third insulation layer 58 is formed on the third and fourth conductive layers 201 and 203, and the fifth and sixth conductive layers 601 and 603 are formed on the third insulation layers 58 in a predetermined pattern.

Next, as shown in FIG. 5B, a fourth photoresist 71 is deposited to cover the fifth and sixth conductive layers 601 and 603. Next, ultraviolet rays are irradiated on the fourth photoresist 71 through the backside of the first substrate 10. Since the second, fourth and sixth conductive layers 163, 203 and 603 are formed of nontransparent material that does not transmit ultraviolet rays, the ultraviolet rays pass only through the openings 1631. As a result, portions of the fourth photoresist 71 corresponding to the openings 1631 absorb the ultraviolet rays.

Next, as shown in FIG. 5C, the ultraviolet ray absorbing portions of the fourth photoresist 71 are developed and removed to form the openings 711 therein. The fifth conductive layer 601 and the third insulation layer 58 are etched through the openings 711. Therefore, openings 718 and the focusing electrode 60 are formed as shown in FIG. 5C.

Referring to FIG. 5D, a fifth photoresist 81 is deposited on the focusing electrode 60 and the third insulation layer 58. Next, ultraviolet rays are irradiated on the fifth photoresist 81 through the backside of the first substrate 10. The fifth photoresist 81 is a positive type where an exposed portion is dissolved. Since the second and fourth conductive layers 163 and 203 are formed of nontransparent material that does not transmit ultraviolet rays, the ultraviolet rays pass only through the openings 1631. As a result, portions of the fifth photoresist 81 corresponding to the openings 1631 absorb the ultraviolet rays.

Next, as shown in FIG. 5E, the ultraviolet ray absorbing portions of the fifth photoresist 81 are developed and removed to form the openings 811 therein. The third conductive layer 201 and the second insulation layer 185 are etched through the openings 811. Therefore, the gate electrodes 20 each having the third and fourth conductive layers 201 and 203 are formed.

Referring to FIG. 5F, a sixth photoresist 91 is deposited on the second insulation layer 185 and the gate electrodes 20. Next, the ultraviolet rays are irradiated on the sixth photoresist 91 through the backside of the first substrate 10. The sixth photoresist 91 is a positive type where an exposed portion is dissolved. Since the second, fourth and sixth conductive layers 163, 203, and 603 are formed of nontransparent material that does not transmit (i.e., blocks or substantially blocks) ultraviolet rays, the ultraviolet rays pass only through the openings 1631. As a result, portions of the sixth photoresist 91 corresponding to the openings 1631 absorb the ultraviolet rays.

Next, as shown in FIG. 5G, the ultraviolet ray absorbing portions of the sixth photoresist 91 are developed and removed to form the openings 911 therein. The etching control layer 183 and the first insulation layer 181 are wet-etched through the openings 911. Therefore, the openings 187 having a relatively uniform diameter through the insulation layers can be formed using the etching control layer 183. In addition, the size of the openings 187 can be reduced through the multi-step etching.

Referring to FIG. 5H, a seventh photoresist 101 is deposited on the first substrate 10 and ultraviolet rays are irradiated on the seventh photoresist 101 through the backside of the first substrate 10. The seventh photoresist 101 is a positive type where an exposed portion is dissolved. At this point, since the second, fourth, and sixth conductive layers 163, 203, and 603 are formed of nontransparent material that does not transmit (i.e., blocks or substantially blocks) ultraviolet rays, the ultraviolet rays pass only through the openings 1631. As a result, portions of the seventh photoresist 101 corresponding to the openings 1631 absorb the ultraviolet rays.

Next, as shown in FIG. 5I, the ultraviolet ray absorbing portions of the seventh photoresist 101 are developed and removed to form the openings 1011 therein. The electron emission regions 30 are formed through the openings 1011 (see FIG. 1).

Next, as shown in FIG. 5J, a paste-phase mixture 80 including an electron emission material and a photosensitive material is deposited on the seventh photoresist 101 through a screen-printing process. Subsequently, ultraviolet rays are emitted toward the resultant layer 80 through the backside of the first substrate 10. Since the second, fourth, and sixth conductive layers 603 are formed of nontransparent material that does not transmit ultraviolet rays, the ultraviolet rays pass only through the openings 1631. As a result, portions of the resultant layer 80 corresponding to the openings 1631 are hardened. The portions that are not hardened are removed through the developing process and the seventh photoresist 101 is also removed. Next, the hardened portions are dried and baked.

Accordingly, as shown in FIG. 5K, the electron emission device 200 having the electron emission regions 30 formed in the openings 1631 can be manufactured.

According to exemplary embodiments of the present invention, the size of the opening can be reduced through the multi-step etching process. In addition, the openings can be uniformly formed through the insulation layers using the etching control layer. Therefore, the density (i.e., a number per unit area) of the electron emission regions can be improved. The amount of light emission from each unit pixel increases, thereby improving the display quality of the light emission device.

Although exemplary embodiments of the present invention have been described in detail hereinabove, it should be clearly understood that many variations and/or modifications of the basic inventive concept taught herein still fall within the spirit and scope of the present invention, as defined by the appended claims and their equivalents.

What is claimed is:

1. An electron emission device comprising:
a substrate;
a cathode electrode on the substrate and having a first opening, the cathode electrode comprising a material that substantially blocks ultraviolet rays;
an electron emission region in the first opening, the electron emission region being adapted to emit electrons;
a gate electrode electrically insulated from the cathode electrode, the gate electrode comprising a material that substantially blocks the ultraviolet rays; and
a plurality of insulation layers between the cathode electrode and the gate electrode,
wherein the plurality of insulation layers comprises first and second insulation layers adjacent each other, the first insulation layer having a first etching rate different from a second etching rate of the second insulation layer.

2. The electron emission device of claim 1, wherein the first insulation layer is an etching control layer, and the first etching rate is less than the second etching rate.

3. The electron emission device of claim 2, wherein the second etching rate is 2-3 times the first etching rate.

4. The electron emission device of claim 2, wherein the second insulation layer is closer to the substrate than the first insulation layer.

5. The electron emission device of claim 4, wherein the second insulation layer has an opening formed through an etching process, wherein a radius of the opening gradually increases toward the substrate.

6. The electron emission device of claim 5, wherein a thickness of the second insulation layer is equal to or less than the radius of the opening.

7. The electron emission device of claim 6, wherein a thickness of the second insulation layer is equal to or less than 90% of the radius of the opening.

8. The electron emission device of claim 2, wherein the etching control layer comprises at least one of silicon oxide or silicon nitride.

9. The electron emission device of claim 8, wherein, when the etching control layer comprises the silicon oxide, the second insulation layer comprises another silicon oxide, a ratio of oxygen to silicon in the etching control layer being greater than a ratio of oxygen to silicon in the second insulation layer.

10. The electron emission device of claim 8, wherein, when the etching control layer comprises the silicon oxide, the silicon oxide has a chemical formula of SiₓO_{y} and satisfies the following condition: 2x≧y.

11. The device of claim 2, wherein a thickness of the etching control layer is 5-10% of a thickness of the second insulation layer.

12. The device of claim 1, further comprising:
a third insulation layer on the gate electrode; and
a focusing electrode on the third insulation layer and comprising a material that substantially blocks the ultraviolet rays.

13. A light emission device comprising:
first and second substrates opposing each other;
a cathode electrode on the first substrate and having a first opening, the cathode electrode comprising a material that substantially blocks ultraviolet rays;
an electron emission region in the first opening, the electron emission region being adapted to emit electrons;
a gate electrode electrically insulated from the cathode electrode, the gate electrode comprising a material that substantially blocks the ultraviolet rays;
a plurality of insulation layers between the cathode electrode and the gate electrode;
a phosphor layer on the second substrate; and
an anode electrode adjacent the phosphor layer on the second substrate,
wherein the plurality of insulation layers comprises a first insulation layer and a second insulation layer, the first insulation layer having a first etching rate different from a second etching rate of the second insulation layer.

14. The light emission device of claim 13, wherein the first insulation layer is an etching control layer, and wherein the first etching rate is less than the second etching rate.

15. The light emission device of claim 14, wherein the second insulation layer has an opening formed through an etching process, wherein a radius of the opening gradually increases toward the substrate.

16. The light emission device of claim 14, wherein the etching control layer comprises at least one of silicon oxide or silicon nitride.

17. The light emission device of claim 16, wherein, when the etching control layer comprises the silicon oxide, the second insulation layer comprises another silicon oxide, a ratio of oxygen to silicon in the etching control layer being greater than a ratio of oxygen to silicon in the second insulation layer.

18. An electron emission device comprising:
a substrate;
a cathode electrode on the substrate and having a first opening, the cathode electrode comprising a material that substantially blocks ultraviolet rays;
an electron emission region in the first opening, the electron emission region being adapted to emit electrons;
a first insulation layer on the cathode electrode;
a second insulation layer on the first insulation layer;
a third insulation layer on the second insulation layer; and
a gate electrode electrically insulated from the cathode electrode by the insulating layers, the gate electrode comprising a material that substantially blocks the ultraviolet rays,
wherein the second insulating layer has an etching rate different from etching rates of the first and second insulating layers.

19. The electron emission device of claim 18, wherein a thickness of the second insulation layer is less than about 10% of a thickness of the first insulation layer.
